(19) United States
(12) Patent Application Publication
(10) Pub. No.: US 2007/0185929 A1
(43) Pub. Date: Aug. 9, 2007

(54) Method and apparatus for processing monitoring

(75) Inventors: Zacky Azoulay, Netanya (IL); Philippe Kahn, Hod Hasharon (IL); Oren Frishberg Barak, Hod Hasharon (IL)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: SAP Portals Isreal Ltd.

(21) Appl. No.: 11/344,756

(22) Filed: Feb. 1, 2006

(51) Int. Cl. G06F 17/30

(52) U.S. Cl. 707/203

(57) ABSTRACT

A method and device for monitoring processing in a multi-user computerized environment, such as a coding and compilation environment. An on-going process checks every predetermined time for new changes in the compiled code. When a change is found, the critical set of entities affected by the change is processed. If the processing succeeds, the system goes on to process the regular set of entities affected by the change. If any of the processing fails, a notification is sent to the person responsible for the change. A status indicator is constantly updated. After a predetermined time, the process checks for new changes and repeats the mentioned steps.

### BACKGROUND OF THE INVENTION

1. Field of the Invention

The present invention relates to development of computerized systems in general, and to a method and apparatus for monitoring processing such as compilation, in particular.

2. Discussion of the Related Art

In organizations, in particular organizations that generate computerized products, such as computer programs, development is severely slowed down when multiple developers are working on common projects. In the past, problems were created due to multiple developers working on the same file or files. In these cases, the changes made to an entity such as a file, a resource or the like, by any person excluding the last to save his changes, were lost. Other problems occurred when developers saved code that could not be compiled by other programmers or is that created run time errors. Another problem occurred when one person saved a first file, and another person working on a different issue saved a second file. If the first and the second saved files were related but incompatible, it was possible that none of the two developers, and optionally additional developers could compile the system, or even worse could not execute the program. Some of these problems were solved by the introduction of source control systems, which enable a programmer to “check out” a file, i.e., to receive write privileges for one or more files. Once the programmer is satisfied with the changes made to the checked out files, the programmer checks in the files such that the revised version is available to all other users and becomes the common version. If another programmer attempts to check out an already checked out file, such request is either refused, or an alert is sent to the requesting programmer that checking in will not be possible unless their changes are merged into the revised file after it has been checked in. Thus, source control systems solve the problem of losing changes due to multiple persons working on the same files. However, such presently available source control systems fail to maintain source compatibility due to incompatible files. Incompatible files are files that the checking in thereof will not necessarily cause a source control problem, rather the uncoordinated changes may result in project or sub-project errors. For example incompatible files can be two separate files having a reference to the same variable, each defining such variable as being of different type. When multiple developers work on the same project or product, and change one or more files affecting one or more inter-dependent sub-projects in a way that is incompatible with other sub-projects, the compilation will likely not succeed resulting in a situation where none of the developers can compile or run the program until the problem is fixed. This problem can be fixed only when the incompatible files are corrected. Sometimes the error is detected and identified only after a full or nearly full compilation cycle, which can take a long time; hours in large systems, thus leading to delays and to further increase in the number of problems per compilation. In addition, delays in compilation and the unavailability of successful compilation products have a direct impact on the work of other teams, such as additional development, testing and deployment. The problem is more severe in large, optionally geographically distributed organizations, in which an overall compilation is performed at a predetermined time, usually at night. Then, if the night compilation fails, none of the developers can work the next day because, valid compilation products will not be available earlier than after the next compilation, which will typically take place during the following night. This, too, can hold back testing, packaging, deployment and other tasks. Another problem arises when a compilation fails. In such case, it may take time to identify the person responsible for the problem, contact that person, show or explain the problem, and wait for the person to fix the problem and check the correction. Such a problem is not likely to present itself at the compilation environment of the programmer, since a reasonable programmer would probably compile the code successfully prior to checking it in. Therefore the problem is likely to result from other files checked out by the programmer, which differ from the corresponding generally available files. Yet another problem may occur when programmers rely on the content of files as was before the files were checked out by another programmer. Such files content may be changed by the other programmer, resulting in incompatibility with the first programmer's changes to other files. In addition, there are processes such as various compatibility checks between files or other entities, which are not performed as a part of a compilation cycle, although performing them can eliminate later run-time errors and save precious development time.

There is therefore a need for a method and apparatus for improving the processing cycle at multi-user computerized development environments. There is also a need for a method and apparatus which will reduce the time during which compilation results and products are not available in multi-developers environment.

### SUMMARY OF THE PRESENT INVENTION

It is an object of the present invention to provide a novel method for monitoring processing entities which overcomes the disadvantages of the prior art. In accordance with the present invention, there is thus provided a method for monitoring a processing environment of entities, the method comprising the steps of determining if one or more files comprising one or more changes was checked into a source control system; determining one or more sets of entities affected by the change; processing the entities and obtaining processing results; and notifying one or more persons about the results of the processing of said entities. Within the method the processing can be compiling or checking compatibility between files, and the file can be a change list. The one or more sets of entities can comprise two sets of entities, a critical set and a regular set. The regular set is processed only if the critical set was processed successfully. The method can further comprise a waiting step before determining if a new file was checked into the source control system. Within the method, the notifying step comprises one or more of the following: updating a web page, updating a database table, sending an e-mail to an at least one person, sending an SMS to an at least one person, sending an instant message to an at least one person, or making a phone call to a person. The person can be a person responsible for an at least one error in the processing, or a supervisor of the person responsible for an error in the processing. The method can further comprise an error correction step for correcting errors in the processing. The method can further comprise a dependency determination step or the steps of erasing all processing results and products and processing all entities. Another aspect of the disclosed invention relates to an apparatus for monitoring a processing environment of entities, the apparatus comprising a dependency determination component for determining one or more sets affected by a change in one or more files; a processing launching component for launching a processing of the sets; a processing result analysis component for analyzing one or more results of the processing of the sets; and a notification component for generating and issuing one or more notifications to one or more persons about the one or more results. The processing can be compilation, or checking compatibility between files. The one or more sets can comprise a critical set a regular set. The file can be a change list. The apparatus can further comprise a change list parsing component for parsing the change list. The apparatus can further comprise a source control communication component for communicating with a source control system, a status update component for updating the results, or an error correction component for correcting one or more processing errors.

Yet another aspect of the disclosed invention relates to a computer readable storage medium containing a set of instructions for a general purpose computer, the set of instructions comprising a dependency determination component for determining one or more sets affected by a change one or more files; a processing launching component for launching a processing of the sets; a processing result analysis component for analyzing one or more results of the processing of the sets; and a notification component for generating and issuing one or more notifications to one or more persons about the results.

### BRIEF DESCRIPTION OF THE DRAWINGS

The present invention will be understood and appreciated more fully from the following detailed description taken in conjunction with the drawings in which:

FIG. 1 is a schematic block diagram of an environment, in which the disclosed invention is used;

FIG. 2 is a flowchart showing the main steps of a preferred embodiment of the disclosed method;

FIG. 3 shows an example of a change list file shown in a viewer /editor application, in accordance with a preferred embodiment of the disclosed method;

FIG. 4 shows an example of a graphic user interface displaying a processing status page, in accordance with a preferred embodiment of the disclosed invention; and

FIG. 5 is a block diagram showing the main components of an apparatus constructed in accordance with a preferred embodiment of the disclosed invention.

### DETAILED DESCRIPTION OF THE PREFERRED EMBODIMENT

The present invention overcomes the disadvantages of the prior art by providing a novel method and apparatus which implement a processing monitoring environment. The present invention provides a processing monitoring apparatus, intended for example for development environments of computerized systems, wherein the processing can be compiling computer instructions. The processing monitoring apparatus preferably communicates with any source control system that provides an Application Program Interface (API). A file is said to be checked out of the source control system if a specific user has requested and received write privileges to such file. As long as such file was not checked back into the source control system, only the specific user has access to the changes he or she made to the file. Thus, other users do not have access to the latest version of the file, comprising the changes, until it is checked back in. A file is said to be checked into the source control system if the latest version of the file, as changed by the user, is made available to all other users of the system and said user surrenders the writing privileges for the file, at which point another user can check out the file, and thus gain exclusive write privileges to that file. The processing monitoring apparatus is preferably constantly active, and periodically queries the source control system for newly checked-in change-list files, wherein a change-list file comprises a list of changed files or entities, such as resources, registry or the like. If no change list file is found, the system preferably waits for a predetermined length of time and then queries the source control system again. If a newly checked-in change list is found, the processing monitoring apparatus determines a critical set, i.e., the sub-projects or other components that are directly affected by the changed files, and optionally the order in which such components should be processed. Next, the processing monitoring apparatus activates processing of these components. If the processing is successful the processing monitoring apparatus proceeds to process other sub-projects or components, named a regular set, which are indirectly affected by the changed files. If the first or the second processing fails, the responsible person is identified, and preferably a notification is sent to such person and optionally to other predetermined list of persons, such as a supervisor, development team members, team leader, or the like. Optionally, a log is kept of all processing monitoring apparatus activities, and the current status and results of the processing can be examined by users according to privileges. In a development environment in which the product is a computerized system, the processing is often compilation of computer instructions. Another processing is, for example, the compatibility check of XML and XIN files. If a pair of XML and XIN files that should be compatible are not, no further processing should be performed, because this can generate severe run-time problem. Yet another processing is checking the compatibility of other files, such as a language file to other components such as resources, or the like.

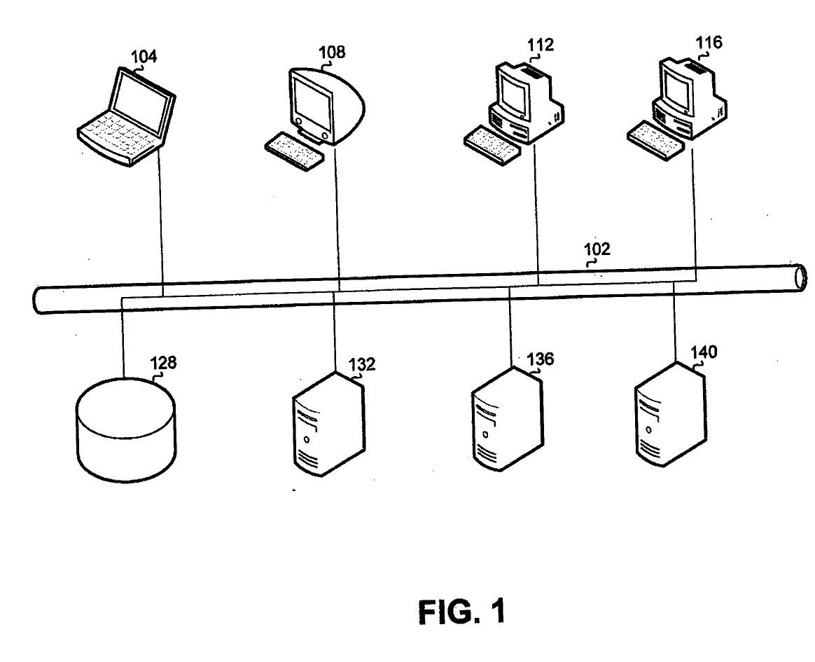

Referring now to FIG. 1, showing a typical non-limiting environment in which the disclosed invention can be used and practiced in accordance with a preferred embodiment of the present invention. The environment is typically a development team, a development group comprising multiple teams, or a multi-group optionally geographically distributed organization developing a computerized system, which requires processing such as compilation as part of the work flow. The environment preferably comprises one or more groups or teams of client machines, using computing platforms such as mainframe, personal, or network computers 108, 112, 116, laptop computers 104 or any other computing device. The environment further comprises at least one storage device 128, for storing files such as developed files or compilation results, an at least one source control server 132, an at least one compilation server 136 and an at least one monitoring server 140. Each one of servers 132, 136, and 140 is a computational device running one or more applications that execute the relevant methods of the present invention. Server 140 runs the programs implementing the disclosed method. Storage device 128, source control server 132, compilation server 136, and monitoring server 140 can be implemented on one or more devices, at any desired distribution, according to the parameters such as load balancing, storage and retrieval speed or the like. One or more of the servers can also be implemented on one or more of client devices 104, 108, 112 or 116. All components of the environment are connected by a local area network, wide area network or another communication mechanism 102 allowing said components to exchange data there between. Each client and each server preferably comprises a computing platform provisioned with a memory device (not shown), a CPU or microprocessor device, and several I/O ports (not shown). Alternatively, each computing platform can be a DSP chip, an ASIC device or the like. Storage 128 can be a magnetic tape, a magnetic disc, an optical disc, a laser disc, a mass-storage device, or the like, allowing storage and retrieval of information from said media. A processing monitoring application, running on server 140 is a set of logically inter-related computer programs and associated data structures that interact to monitor, plan and launch the necessary processing, monitor the processing results, and optionally notify one or more persons, such as the person responsible for failure of processing, a supervisor or other predetermined person or persons, and the like.

It will be appreciated by people skilled in the art that the method is applicable to multiple types of processing, such as compilation or compatibility checks discussed above, and is not limited to a specific environment. It will also be appreciated that the method and apparatus are suitable for geographically distributed environments, and to environments comprising different or additional types of devices.

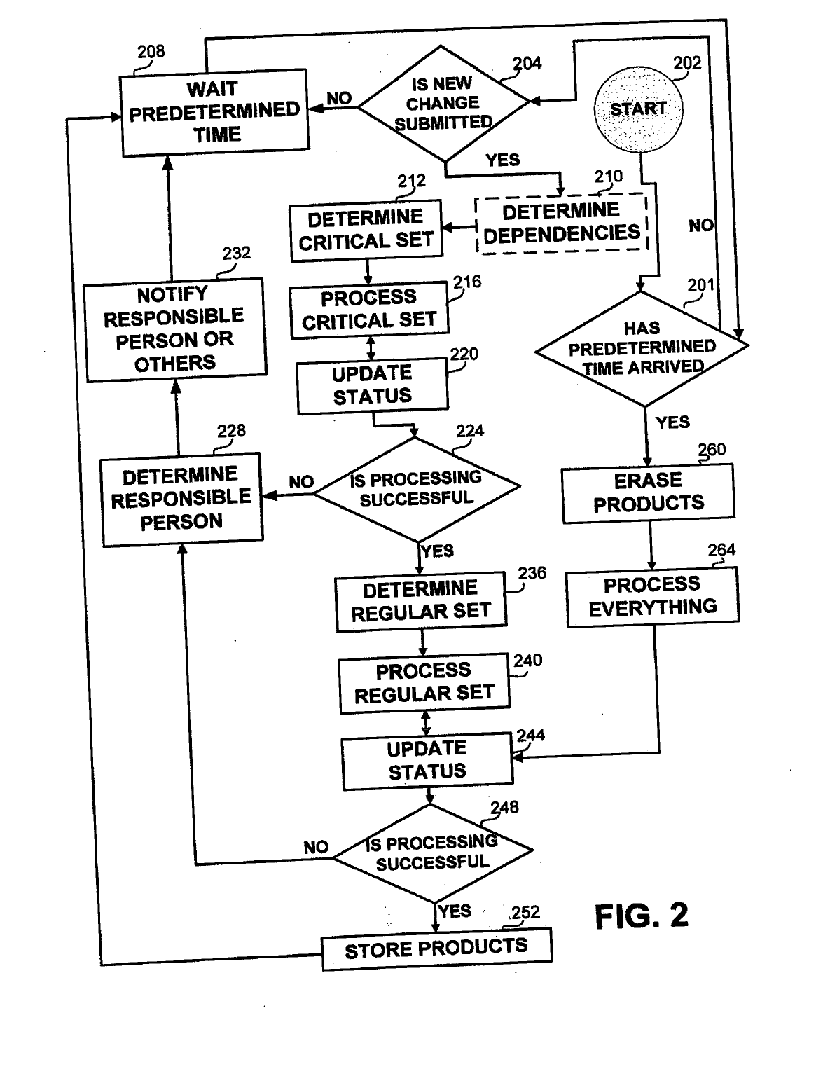

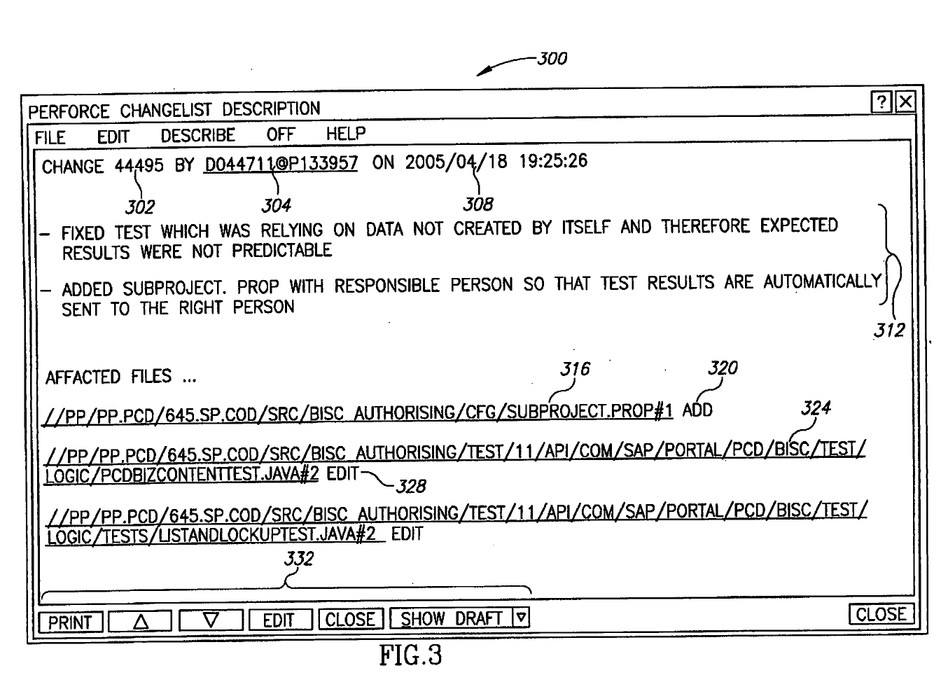

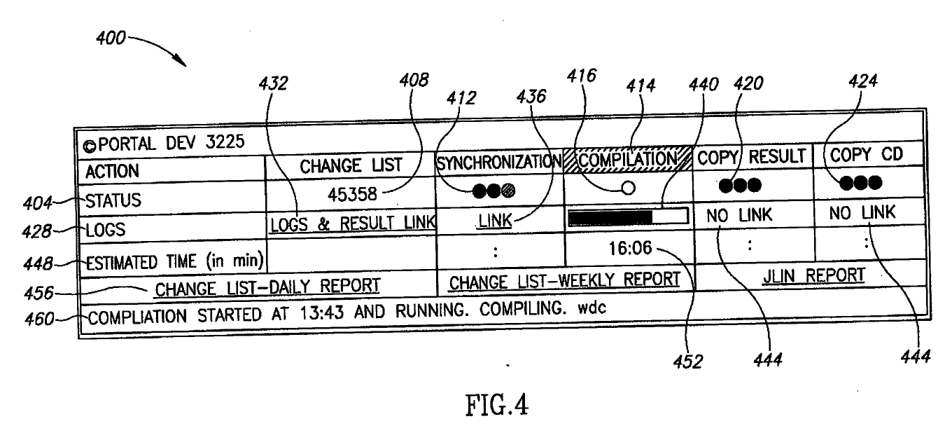

Referring now to FIG. 2, showing a flowchart of the main steps in accordance with a preferred embodiment of the disclosed method, as executed by monitoring server 140 of FIG. 1. At step 202 the method according to a preferred embodiment of the present invention starts, preferably by starting a monitoring loop of the environment. Optionally, said monitoring is continuous or is preferably executed for a lengthy period of time or for as long as the monitoring server 140 of FIG. 1 is active. At step 201, it is determined whether a predetermined time has arrived. Preferably, every predetermined time, for example everyday at midnight, the apparatus should perform an overall processing of all components in the system. If the predetermined time has not arrived, at step 204 the existence of one or more newly checked-in files is determined through communication with source control server 136 of FIG. 1. The processing monitoring apparatus preferably searches for checked-in change list files. A change list file comprises a list of all the files that were checked in, in association with a specific change by a user. Change lists are further detailed in association with FIG. 3 below. If no new change list exists, the system waits at step 208 for a predetermined period of time, preferably between one mSec and a number of hours, typically about five minutes, after which the system wakes up and checks again. If a new change list is available, at step 210 the apparatus optionally determines, or refreshes the dependencies. The refreshing can be done every predetermined time, anytime a change occurred or according to any other scheme. Then at step 212 the apparatus determines based on the dependencies the critical set, i.e. those entities within the system that are directly affected by the files mentioned in the change list, and optionally the relative order in which such entities should be processed, in case of inter-dependencies. For example, such entities can be other files, projects, sub-projects such as modules, DLLs, executable components or others, which may include, but not limited to computer instructions, variable definitions, global variable definitions, database definition, and the like. Alternatively, the system determines the existence of newly checked in files which are not change lists, and analyzes the entities depending on these files. When a source control system is used, the files are synchronized with the source control, i.e., the latest version of each involved file is retrieved. At step 216 the critical set is processed. In the case of a compilation environment, the processing comprises a compilation of the entities identifies in the critical set on compilation server 136 of FIG. 1. Since the components of the critical set are the most sensitive to the changes, processing the critical set first, provides early alert for errors, without processing unnecessary entities and leaving the system without valid processing products which are consistent with the changed files. The compilation parameters can be hard-coded, written in a database, a registry or the like, or determined dynamically according to various considerations, such as load balance, accessibility or the like. At step 220, the processing status is updated periodically, for example every few seconds, throughout the processing. Other updating time can be established according to predetermined rules or according to the load the processing task requires. Preferably such periodically updating time is from about few milliseconds to about any number of hours. In the case of compilation, the apparatus determines the processing status by communicating with compilation server 136 of FIG. 1, parsing the log file of the compilation, determining the creation or change dates and times of the products, or in any other method. The update is performed through updating a web page, a database table, or any other medium that enables a user to examine the current status of the processing. A possible implementation using a web page is further detailed in association with FIG. 4 below. Optionally, if the processing fails, the person responsible for the failure is determined at step 228. The responsible person can be the one who changed any of the files on which processing the error occurred, but other alternatives exist, such as a person who unjustifiably expected certain contents of such file. The responsible person can also be a predetermined person or other persons associated with such predetermined person or the person who checked in the file, such as a team leader, developing team mates and the like. At step 232 the responsible person is notified of the problem, by e-mail, instant message, SMS, phone call or any other method. The notification preferably includes the relevant data for the message, such as a file name, a specific error message or any other data which can be useful for correcting the error. The notice can also be sent to other persons, such as the group leader of the person, a supervisor, or the like. The message can also include other parameters, such as the names of the other recipients, additional instructions, time tables for performing the correction of errors, a pointer to the last time a processing was successful, for example the identifier of the last change-file that initiated a successful compilation, or the like. In addition, recurrent notifications of the problem waiting to be fixed can be sent at predetermined time intervals, or whenever an additional problem occurs, such as a processing failure due to another person failing to compile after additional changes. Then at step 208 the apparatus waits for a predetermined period of time, and then repeats step 201 for determining whether in the predetermined time has arrived. It will be evident to those skilled in the art that step 208 is optional and may be removed providing a continuous and on-going determination whether a new file is checked in. The waiting is also intended to enable the responsible person to correct the errors the apparatus provides notice with respect thereof. If the processing at step 204 succeeded, the apparatus proceeds to determine the regular set at step 236. The regular set comprises all the entities that are affected indirectly by the new changes, and optionally the order in which they should be processed. At step 240, the regular set is processed, and at step 244 the status is updated periodically in a similar manner to step 220 above. At step 248, it is determined by the apparatus if the processing of the regular set was completed successfully, in which case the results are stored at step 252 on storage device 128 of FIG. 1. The processing of a set successfully denotes the error free processing of the said set. Otherwise, the responsible person or other persons to be notified is determined at step 228 and notified at step 232 as described above. Whether the processing was successful or not, the system preferably waits for a predetermined time at step 208 to allow the person to correct the error, or for a new change to be checked in. The two-step processing of the critical set and the regular set provides as early as possible detection and notification of processing problems, thus keeping the system as much of the time as possible in functional condition with valid processing products. Successful processing of the regular set ensures that the global processing which might occur many hours or even days later, such as a night compilation, will be successful as well. In an alternative embodiment of the present invention additional notices can be sent to the responsible or other persons if a new file is not checked in within a predetermined period of time. In addition, in another preferred embodiment of the present invention the apparatus of the present invention may optionally reject the checked in file and continue use of a previously checked in file known to be error free, preferably until such time when a new error free file is checked in. If at step 201 it is determined that the predetermined time, for example midnight, has arrived, then the system erases all the products at step 260 and starts a “clean” processing of all the entities in the system at step 264. Once the processing is complete, the system continues at step 244 as described above.

There are a few preliminary steps which should preferably be taken prior to first time processing. One such step is determining the dependencies between entities as described in association with step 210 of FIG. 2 above. This step is preferably performed once, when the system is deployed and anytime there is an addition or deletion of files belonging to projects, subprojects or other entities, rather than merely changes to existing files. Optionally the processing to refresh the dependencies is performed at predetermined time or according to the occurrence of a predetermined, such as checking in a new file, or on or after other changes occur in the relevant project and are notified to the apparatus of the present invention. The dependencies determined at this step enable the determination of the critical and the regular set influenced by changes to specific files. The dependencies also dictate which files have been changed and should therefore be synchronized, i.e., retrieved from the source control system in order to generate consistent and valid compilation results. The non-changed files are identical to the files checked in to the source control and should generally not be retrieved. Another preliminary step is determining or estimating the time each processing takes, in order to present the information to a user as discussed in association with FIG. 4 below, so that the user can take the information into account when planning when to check in a file, or otherwise initiate processing. Determining the critical set and the regular set can be carried out in a variety of ways. It is possible during the deployment of the system, to manually predefine for each project, subproject, or another entity the list of other entities it depends on. Then, when a file in an entity changes, the critical set is preferably updated to comprise such changed entity, and the regular set is preferably updated to comprise all other entities which include the said changed entity in their list. Alternatively, the critical set comprises other entities that call and use the changed entities. In yet another alternative, a thorough parsing of the entity description, such as the project file, is performed and only changes in areas that influence the public parts cause compilation of further entities as part of the regular set. It will be evident to those in the art that the smaller the critical set, the faster the average time it takes to detect an error.

Referring now to FIG. 3, showing a dedicated editor, generally referenced 300, presenting a change list. Each change list comprises a unique ID 302, and a name, ID, e-mail address or another unique identifier 304 of its creator. Optionally, the change list further comprises its creation time and date 308. Preferably, the change list comprises free text 312 written by the creator, for example text describing the purpose, the principles or any other data relevant to the change. The change list further comprises a list of the changed files 316, 324 and an indication of the type of the change, such as addition 320, editing 324, delete (not shown), or the like. A deletion of a file can be described explicitly as deletion, or as editing the file representing the entity containing that file, such as a project file. Editor 300 optionally further comprises buttons 332 for editing the presented or other change lists or to further control the editor window or the content thereof or to perform other actions such as printing a hardcopy, showing additional files, allowing editing, and the like.

Referring now to FIG. 4, showing an exemplary status report of the apparatus as used in a software development environment, in accordance with a preferred embodiment of the present invention. The status report, generally referenced 400 preferably comprises a status line 404, a logs line 428, an estimated time line 448, a report line 456 and a status line 460. To better explain the status report presentation only a single status line and log are shown in the present example, although it will be understood that multiple status line, logs and projects can be shown at the same time on a single screen. Status line 404 shows the identifier of the handled change list 408, and the status of the different phases of the process, i.e., the synchronization with the source control system 412, compilation phase 416, which is the currently active process which can be seen from the highlighted column head 414, copy of products phase 420 and copy CD phase 424 which generates an installation disk. Logs line 428 comprises a link to a log file to each of the completed tasks, i.e. synchronization 436 in the presented status page. The compilation is in process, so a progress bar 440 is shown, and no progress bar or log file 444 is available for the copy and CD creation processes which have not started yet. For each stage, when the stage is completed, the progress bar is replaced with a link to the results of the stage. Estimated time line 456 comprises estimation to the time the currently active process will take 452, as determined or estimated in past processing, or by other methods, e.g., 16:06 minutes for the compilation in the presented case. Reports line 456 comprises links to various available reports, and status line 460 indicates when the action was started and what is the current stage, for example which file is currently being compiled. The status line can preferably use colors to indicate the compilation status or phase to enhance the graphical presentation and allow quick identification of the overall status of large and complex projects having multiple status lines and logs.

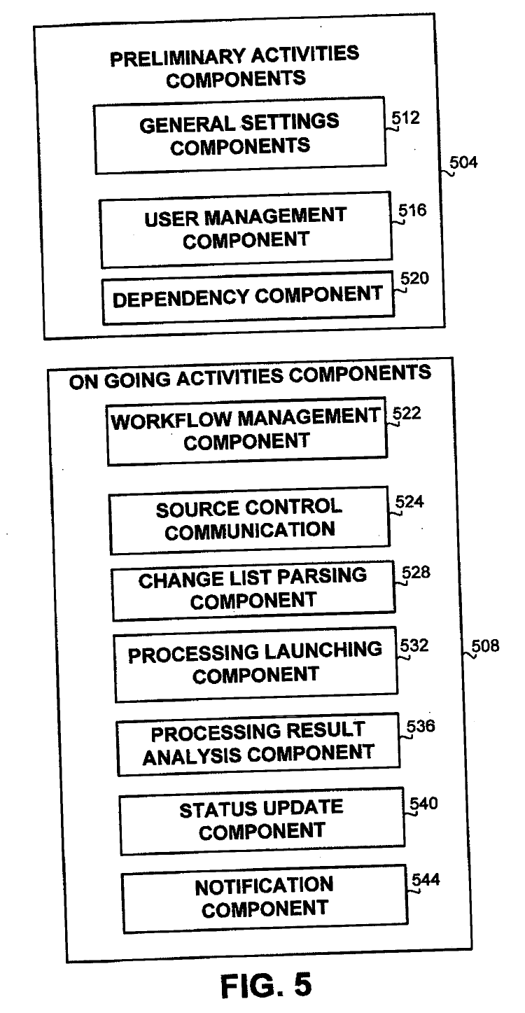

Referring now to FIG. 5, showing a block diagram of the main components in the preferred embodiment of the apparatus of the present invention. Such components are preferably executable software components, which interact to perform the steps of the methods described in association with FIG. 2 above. Such components can be stored on a fixed or portable optical media storage device and be loaded into a memory device for execution as the need arises or as they are called to operate. Depending on the specific technology and implementation used, each described component can comprise one or more components, module, files, set of instructions and the like elements enabling the execution of the method of the present invention on any suitable platform now known to persons skilled in the art or later developed. Alternatively, two or more described components can be implemented in a single software component, a different division of the functionalities to software components can be designed, or any combination of the above. The components can be divided into a group of components that perform preliminary activities 504 and a group of components that perform on-going activities 508. However, this distinction is mainly logical and does not imply implementation limitations, as components from one group can be activated by components from the other group. Preliminary activities group 504 comprises a general setting component 512, which receives or one or more sets of parameters or variables related to or associated with the apparatus of the present invention or the system upon which it is executed, such as the addresses of the servers, the predetermined time which the method should wait before trying to recompile the system after a compilation failed, and the like. Preliminary activities group 504 further comprises user management components 516, responsible for storing and retrieving details associated with each user, such as his or her ID, e-mail address, telephone number or other characteristics, including the relevant supervisor or subordinates, user privileges, projects or sub-projects such user is associated with and the like information. Another component comprised in the preliminary activities component group 504 is dependency determination component 520. Component 520 is responsible for determining the inter-dependencies between entities, including files, projects, subprojects or the like. These dependencies are later used to determine the critical set and the regular set affected by one or more changes in one or more files or groups of files. The dependencies are determined at the deployment of the system and whenever a change in the inter-dependencies between entities such as sub-projects, takes place. On-going activities component group 508 comprises a workflow management component 522, which is responsible for controlling the flow of the method shown in association with FIG. 2 above, communicating with other components of the apparatus, such as components comprised in group 508, or processes external to the apparatus such as a compiler. Group 508 further comprises source control communication component 524, responsible for communication with the source control system. The employed source control system should provide an Application Program Interface in order to be able receive control commands such as a command to synchronize files, and provide information such as the existence of a newly checked in change list. Another component is change list parsing component 528, responsible for parsing a newly checked in change list, and getting all the required information, including the person responsible for the changes, the changed files, the types of changes, and the like. Yet another component is processing launching component 532. component 532 is responsible for producing the correct control commands for processing the required set as determined by dependency determination component 520 for the files appearing in the processed change list, and for storing the results of the processing. The required set can be the critical set or the regular set. In the compilation case, the processing command is a compilation command, using the relevant flags and options. A component corresponding to processing launching component 532 is processing result analysis component 536, which is responsible for retrieving the results of the processing and deducing the relevant conclusions, i.e., whether to go on to the next stage of the processing, whether to employ the products of the processing, what is the source of an error, who is the responsible person, and the like. Status update component 540 is responsible for updating the web page, data base table or any other way used to communicate the status of the system to a user. Additionally, a log file of all the actions taken by the system is kept for later reference by users. Notification component 544 is responsible for generating and sending a notification to the person responsible for an error and optionally to his or her supervisor, processing supervisor or the like. The notification preferably comprises data required to identify and fix the problem. The apparatus can further comprise an error correction component, for correcting all the errors that can be corrected without a user's intervention, such as syntax errors or others. In another preferred embodiment, the method can employ a post-processing step, for example in the case of a computerized system, the method can include one or more testing steps. In other preferred embodiments, the method can employ other techniques for querying about a change in one or more files, rather then every predetermined amount of time. For example, the disclosed apparatus can receive notifications from the source control system concerning changed files, rather then querying the system. The changes can relate to any files or only to files of predetermined types. Another variant of this embodiment is using a “hot folder” which is tracked for changes and placing change lists in such folder, using sockets or the like. Another alternative is to enable “on demand” processing by a user, in which the user initiates the processing, rather then the apparatus monitoring an entity such as a clock, a folder, a socket or the like. The method can further apply organizational rules, such as alerting one or more users about changing open source files, tracking the changes to important system-wide files and others. The method and apparatus can further supply statistics as to the delays caused by each team member, the responsiveness and the time it took the team member to correct a mistake, and the like.

The presented method and apparatus discloses an on-going process of monitoring changes to a system, and a two-step processing method, in which the more critical parts which are directly affected by recent changes and are therefore more error-prone are processed first, in order to provide an early indication for problematic changes. If the first processing passed without errors, than other parts which depend on the processed subprojects are processed. When any processing fails, a notice is sent to the responsible person so that he can fix the problem as soon as possible. Optionally, the message is sent also the supervisor of that person. This method reduces the inconsistency time of the system and assures fast problem correction. The method and apparatus improve the quality of the product, and promotes better performance of team members who are more likely to increase unit testing so as not to be held responsible for long delays.

It will be appreciated by persons skilled in the art that the disclosed invention can be used. not only for code compiling but also to other types of processing of inter-dependent files and groups of files. It will also be appreciated that similar or equivalent versions of the method are possible, such as more than two tiers of processing, additional actions to be taken in the case of a success or a failure of the processing, for example automatic error correction when the error is straight-forward such as a simple syntax error, and the like.

It will be appreciated by persons skilled in the art that the present invention is not limited to what has been particularly shown and described hereinabove. Rather the scope of the present invention is defined only by the claims which follow.

I/We claim

1. A method for monitoring a processing environment of entities, the method comprising the steps of:
determining if an at least one file comprising an at least one change was checked into a source control system;
determining an at least one set of entities affected by the at least one change;
processing the at least one set of entities and obtaining processing results; and
notifying an at least one person about the results of the processing of said at least one set of entities.

2. The method of claim 1 wherein the processing is compiling.

3. The method of claim 1 wherein the processing is checking compatibility between files.

4. The method of claim 1 wherein the file is a change list.

5. The method of claim 1 wherein the at least one set of entities comprises two sets of entities, the first set is a critical set and the second set is a regular set.

6. The method of claim 5 wherein the regular set is processed only if the critical set was processed successfully.

7. The method of claim 1 further comprising a waiting step before determining if a new file was checked into the source control system.

8. The method of claim 1 wherein the notifying step comprises one or more of the following: updating a web page, updating a database table, sending an e-mail to an at least one person, sending an SMS to an at least one person, sending an instant message to an at least one person, or making a phone call to an at least one person.

9. The method of claim 8 wherein the at least one person is a person responsible for an at least one error in the processing.

10. The method of claim 8 wherein the at least one person is a supervisor of the person responsible for an at least one error in the processing.

11. The method of claim 1 further comprising an error correction step for correcting an at least one error in the processing.

12. The method of claim 1 further comprising a dependency determination step.

13. The method of claim 1 further comprising the steps of:
erasing all processing results and products; and processing all entities.

14. An apparatus for monitoring a processing environment of entities, the apparatus comprising:
a dependency determination component for determining an at least one set affected by a change in an at least one file;
a processing launching component for launching a processing of the at least one set;
a processing result analysis component for analyzing an at least one result of the processing of the at least one set; and
a notification component for generating and issuing an at least one notification to an at least one person about the at least one result.

15. The apparatus of claim 14 wherein the processing is a compilation.

16. The apparatus of claim 14 wherein the processing is checking compatibility between files.

17. The apparatus of claim 14 wherein the at least one set comprises two sets the first is a critical set and the second is a regular set.

18. The apparatus of claim 14 wherein the at least one file is an at least one change list.

19. The apparatus of claim 18 further comprising a change list parsing component for parsing the at least one change list.

20. The apparatus of claim 14 further comprising a source control communication component for communicating with a source control system.

21. The apparatus of claim 14 further comprising a status update component for updating the at least one result.

22. The apparatus of claim 14 further comprising an error correction component for correcting an at least one processing error.

23. A computer readable storage medium containing a set of instructions for a general purpose computer, the set of instructions comprising:
a dependency determination component for determining an at least one set affected by a change in an at least one file;
a processing launching component for launching a processing of the at least one set;
a processing result analysis component for analyzing an at least one result of the processing of the at least one set; and
a notification component for generating and issuing an at least one notification to an at least one person about the at least one result.
